(19) United States
(12) Patent Application Publication
(10) Pub. No.: US 2002/0025369 A1
(43) Pub. Date: Feb. 28, 2002

(54) Sauce or soup made from water

(76) Inventors: Rudolf Haindl, Salzburg (AT); Hans Mandl, Pfunds (AT)

Correspondence Address: Lorusso & Loud, 440 Commercial Street, Boston, MA, 02109, US

(21) Appl. No.: 09/814,564

(22) Filed: Mar. 22, 2001

(30) Foreign Application Priority Data
Mar. 22, 2000 (AT) A487/2000

(51) Int. Cl. A23L 1/238

(52) U.S. Cl. 426/589

(57) ABSTRACT

A sauce or soup comprising water, a pre-prepared dairy product, at least one taste carrier and preferably at least one binding agent, wherein the pre-prepared dairy product contains at least 60% cream and at least 0.5% gelatin. In accordance with a preferred embodiment the pre-prepared dairy product consists only of cream and gelatin.

The invention concerns a sauce or soup comprising water, a pre-prepared dairy product, at least one taste carrier and preferably at least one binding agent, and a process for the production of such a sauce or soup. The invention further concerns a process for preparing a ready-to-consume sauce or soup produced in particular in accordance with that process, as well as a sauce or soup container for carrying out that process.

A very wide range of different ready-to-eat sauces and soups which are produced from a base, binding agents and cream, are already used in gastronomy. Sauces and soups of that kind are protected from being spoilt and ruined by bacteria by being boiled up before use. It has been found however that there is the disadvantage that sauces or soups of that kind, which are based on milk or cream, after being boiled up, can then be stored only to a very limited extent. Attempts to increase the storability of products of that kind by cooling and respective heating to over 100° C. failed because the product when treated in that way does not remain homogeneous, by virtue of milk constituents, for example caseinates, coagulating.

An object of the present invention is to provide a novel sauce or soup which avoids the above-indicated disadvantages and which is distinguished in particular by a long storage life.

In accordance with the invention, to attain that object, there is provided a sauce or soup comprising a pre-prepared dairy product, in which the pre-prepared dairy product contains at least 60% cream and at least 0.5% gelatin, wherein in particular cream with a fat proportion of between 10% and 20%, preferably 15%, is suitable. That fat proportion is desirably lower than that of normal cream with 36% fat.

If the pre-prepared dairy product has an animal fat proportion of between 10% and 20% and a gelatin proportion of between 1% and 3%, preferably between 1% and 1.5%, that has a particularly advantageous effect on the storage capability of the novel sauce or soup. It is possible to achieve a storage capability of between 14 and 16 days if the pre-prepared dairy product only consists of cream and gelatin.

In general, the mixture of the individual ingredients will be so selected that the sauce or soup has a total fat proportion of between 2% and 40%, preferably between 15% and 17%, in which respect in accordance with a further embodiment it can be provided that, besides the fats contained in the pre-prepared dairy product and possibly in the taste carrier, the novel sauce or soup contains further animal or vegetable fats.

As the pre-prepared dairy product binds caseinates, in accordance with a further aspect of the invention, in order to permit multiple heating of the novel sauce or soup, it is possible to provide that the proportion of the pre-prepared dairy product is between 5% and 80%, preferably being 40%. In a preferred embodiment the proportion of water is between 250% and 75%, preferably being 40%, the proportion of the taste carrier is between 5% and 45%, preferably being about 15%, and the proportion of the binding agent is between 1% and 25%, preferably being between 6% and 7%. That provides that the novel sauce or soup has in particular a high level of stability and nonetheless no longer has to be bound to be of such high viscosity, that is to say it is of thinner consistency.

A suitable taste carrier is in particular one which contains at least a portion of butter and/or butter flavouring, a portion of spices or herbs and a portion of acidification agent, preferably lemon juice. A particularly good taste can be achieved for the sauce or soup if the sauce or soup has a proportion of butter and/or butter flavouring of between 5% and 40%, preferably 8%, a proportion of spice of about 3% and a proportion of acidification agent of about 3%.

A suitable binding agent is in particular one which contains at least a portion of wheat flour and/or ground rice and/or potato starch flour and preferably a portion of guar seed flour, wherein in regard to the consistency of the sauce or soup it has proven to be particularly advantageous if the sauce or soup has a proportion of wheat flour and/or ground rice and/or potato starch flour of between 1% and 15%, preferably 5%, and a guar seed proportion of between 0.1% and 6%, preferably between 1% and 2%.

The invention further seeks to provide a process for the production of a sauce or soup comprising water, a pre-prepared dairy product, at least one taste carrier and preferably at least one binding agent.

In accordance with the invention a process of that kind is characterised by the following steps:

a) producing a (powder) mixture,

b) heating the pre-prepared dairy product,

c) stirring the (powder) mixture into the heated pre-prepared dairy product,

d) mixing that mixture with water, and

e) boiling up that mixture containing at least water, a pre-prepared dairy product and a (powder) mixture,

wherein, in accordance with a further aspect of the invention, it has been found to be particularly advantageous if the (powder) mixture contains at least one taste carrier and preferably at least one binding agent. It will be appreciated that there is also the possibility of the powder mixture being firstly boiled up in water and the pre-prepared dairy product only then subsequently being dissolved therein. In a preferred embodiment it can further be provided that the powder mixture contains a pre-prepared dairy product, at least one taste carrier and preferably at least one binding agent, so that, to produce the novel sauce or soup, that powder mixture only needs to be boiled up with the appropriate amount of water. There is however also the possibility of heating the pre-prepared dairy product which is preferably present in cuttable form, and restoring it to a cuttable form again after the powder mixture has been stirred in, by cooling. That therefore forms a semi-finished product for commercial cooking, which is distinguished in particular by a long storage life and accurate portionability.

A further object of the invention is to provide a novel process for preparing a ready-to-consume sauce or soup.

In accordance with the invention, that is achieved in that the sauce or soup is foamed up with a gas which is under pressure. That operation of foaming up the sauce or soup with a gas which in accordance with a further aspect of the invention is nitrogen, in particular dinitrogen monoxide, imparts a light and creamy appearance to the sauce or soup.

If the sauce or soup which is preferably made from water, a pre-prepared dairy product, at least one taste carrier and preferably at least one binding agent is foamed up in accordance with a preferred embodiment in a closed container, skin formation can be avoided thereby. In addition, the sauce or soup treated in that way is protected from being spoilt by bacteria for a longer period of time than sauces or soups which are conventionally stored. In order to permit particularly simple, fast and precisely portionable preparation, in particular of hot pouring sauces, it can be provided that the sauce or soup is heated in the closed container which is under pressure.

There is thus provided a sauce or soup which, in contrast to the known sauce products, does not have to be bound to a highly viscous consistency, which is of a light and creamy appearance, which can be repeatedly heated and cooled without instability occurring and which can thus keep for between 14 and 16 days and which nonetheless in terms of the formation of the main base is sufficiently stable to be protected from the action of the pressure and not to lose its homogeneity.

The invention further seeks to provide a sauce or soup container for carrying out the process for preparing a ready-to-consume sauce or soup.

In accordance with an aspect of the invention it is provided that the sauce or soup container is a pressure container, in the interior of which the sauce or soup is accommodated, in which respect it will be provided more especially that the interior is coated with a material which is suitable for a foodstuff. It has been found to be particularly desirable in terms of simple and reliable handling if the sauce or soup container has an outlet valve arrangement which is preferably in the form of a pressure-limiter valve, for portionable delivery of the sauce or soup. A preferred embodiment provides that the sauce or soup container has a device for introducing a gas which is under pressure into the interior which accommodates the sauce or soup, in which respect it has been found to be particularly advantageous if the device for introducing the gas is designed for the use of gas capsules. Steel is particularly suitable as the material for the sauce or soup container according to the invention. However, it is also possible to use other materials such as for example coated aluminum.

An example of the production of a cream-brandy sauce is described hereinafter (all percentages are given in percent by weight):

20.45% of taste carrier comprising 15 grams of brown sauce extract, 45 grams of dried bacon powder (for example Speck-Plantex MHA 11), 6 grams of ground onion, 30 grams of butter, 0.1 gram of ground pepper, 0.5 gram of marjoram, 6 grams of butter flavouring and 4 grams of brandy are mixed with 2.87% of binding agent (15 grams of wheat flour) and subsequently stirred into 38.34% of heated, pre-prepared dairy product (comprising 98.5% of 15%-fat cream and 1.5% of high-lead gelatin). To that mixture there was then added 38.34% of water, followed then by heating to over 1000, and the mixture is left to boil until complete dissolution of the taste carrier and the binding agent occurs.

1. A sauce or soup comprising water, a pre-prepared dairy product, at least one taste carrier and preferably at least one binding agent, characterised in that the pre-prepared dairy product contains at least 60% cream and at least 0.5% gelatin.

2. A sauce or soup as set forth in claim 1 characterised in that the pre-prepared dairy product has an animal fat proportion of between 10% and 20% and a gelatin proportion of between 1% and 3%, preferably between 1% and 1.5%.

3. A sauce or soup as set forth in claim 1 or claim 2 characterised in that the cream used in the pre-prepared dairy product has a fat proportion of between 10% and 20%, preferably 15%.

4. A sauce or soup as set forth in one of the preceding claims characterised in that the pre-prepared dairy product consists only of cream and gelatin.

5. A sauce or soup as set forth in one of the preceding claims characterised in that the proportion of the pre-prepared dairy product is between 5% and 80%, preferably 40%.

6. A sauce or soup as set forth in one of the preceding claims characterised in that the proportion of water is between 25% and 75%, preferably 40%.

7. A sauce or soup as set forth in one of the preceding claims characterised in that the proportion of the taste carrier is between 5% and 45%, preferably about 15%.

8. A sauce or soup as set forth in one of the preceding claims characterised in that the taste carrier contains at least a portion of butter and/or butter flavouring, a portion of spices and a portion of acidification agent, preferably lemon juice.

9. A sauce or soup as set forth in claim 8 characterised in that the sauce or soup has a proportion of butter and/or butter flavouring of between 5% and 40%, preferably 8%, a proportion of spice of about 3% and a proportion of acidification agent of about 3%.

10. A sauce or soup as set forth in one of the preceding claims characterised in that the proportion of the binding agent is between 1% and 25%, preferably between 6% and 7%.

11. A sauce or soup as set forth in one of the preceding claims characterised in that the binding agent contains at least a portion of wheat flour and/or ground rice and/or potato starch flour and preferably a portion of guar seed flour.

12. A sauce or soup as set forth in claim 11 characterised in that the sauce or soup has a proportion of wheat flour and/or ground rice and/or potato starch flour of between 1% and 15%, preferably 5%, and a proportion of guar seed flour of between 0.1% and 6%, preferably between 1% and 2%.

13. A sauce or soup as set forth in one of the preceding claims characterised in that the sauce or soup contains further animal fats, preferably sweet cream.

14. A sauce or soup as set forth in one of the preceding claims characterised in that besides the animal fats the sauce or soup also contains vegetable fats.

15. A sauce or soup as set forth in one of the preceding claims characterised in that the sauce or soup has a total fat proportion of between 2% and 40%, preferably between 15% and 17%.

16. A process for the production of a sauce or soup comprising water, a pre-prepared dairy product, at least one taste carrier and preferably at least one binding agent, characterised by the following steps:
a) producing a powder mixture,
b) heating the pre-prepared dairy product,
c) stirring the powder mixture into the heated pre-prepared dairy product,
d) mixing that mixture with water, and
e) boiling up said mixture containing at least water, a pre-prepared dairy product and a powder mixture.

17. A process as set forth in claim 16 characterised in that the powder mixture contains at least one taste carrier and preferably at least one binding agent.

18. A process as set forth in claim 16 characterised in that the powder mixture contains a pre-prepared dairy product, at least one taste carrier and preferably at least one binding agent.

19. A process for preparing a ready-to-consume sauce or soup which is foamed up with a gas which is under pressure, characterised in that the sauce or soup is made from water, a pre-prepared dairy product, at least one taste carrier and preferably at least one binding agent.
